(19) United States
(12) Patent Application Publication
(10) Pub. No.: US 2010/0071167 A1
(43) Pub. Date: Mar. 25, 2010

(54) FOLDING-TYPE ELECTRONIC DEVICE

(75) Inventor: MAO-HSIANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/346,826

(22) Filed: Dec. 30, 2008

(30) Foreign Application Priority Data
Sep. 19, 2008 (CN) 200810304584.6

(51) Int. Cl. E05F 5/02

(52) U.S. Cl. 16/86 A; 16/82

(57) ABSTRACT

An exemplary electronic device includes a main body, a cover, a first magnet, and a second magnet. The cover is rotatably connected to the main body. The first magnet is positioned in the main body. The second magnet is positioned in the cover. A polarity of the first magnet and a polarity of the second magnet are the same, such that a repelling magnetic force is produced when the cover is rotated towards the main body to prevent the cover from striking the main body.

### BACKGROUND

1. Technical Field

The present disclosure relates generally to electronic devices and, more particularly, to a folding-type electronic device.

2. Description of the Related Art

A folding-type electronic device such as a folding-type mobile phone, a notebook computer, or a folding-type personal digital assistant (PDA) generally has a main body and a cover with a display pivotally mounted on the main body via a hinge assembly.

Referring to FIG. 4, a typical folding-type mobile phone 10 includes a main body 11 and a cover 12 rotatably connected to the main body 11. A plurality of keys 111 is positioned on the main body 11, and a display 121 is positioned in the cover 12. The main body 11 also includes two bumpers 122 formed adjacent to a distal end of the cover 12, thereby preventing the cover 12 from unduly striking the main body 11. Therefore, the electronic components in the main body 11 or the cover 12 are cushioned from damage by a collision of the main body 11 and the cover 12.

However, the bumpers 122 are generally made of rubber. Thereby, the bumpers 122 are easily worn out and torn after a period of time. In addition, the elastic properties of the bumpers 122 may worsen after a short period. Therefore, a striking force created between the main body 11 and the cover 12 cannot be reduced sufficiently after a short service period, and the electrical components in the main body 11 may be damaged by the striking force between the main body 11 and the cover 12.

Therefore, a folding-type electronic device to solve the aforementioned problems is desired.

### SUMMARY

An electronic device includes a main body, a cover, a first magnet, and a second magnet. The cover is rotatably connected to the main body. The first magnet is positioned in the main body. The second magnet is positioned in the cover. A polarity of the first magnet and a polarity of the second magnet are the same, such that a repelling magnetic force is produced when the cover is rotated towards the main body to prevent the cover from striking the main body.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present folding-type electronic device. Moreover, in the drawings, like reference numerals designate corresponding parts throughout the several views.

FIG. 1 is an isometric view of an electronic device of a first embodiment in an open state.

FIG. 2 is a side view of the electronic device of FIG. 1 in a closed state.

FIG. 3 is an isometric view of an electronic device of a second embodiment in an open state.

FIG. 4 is an isometric view of a typical folding-type mobile phone.

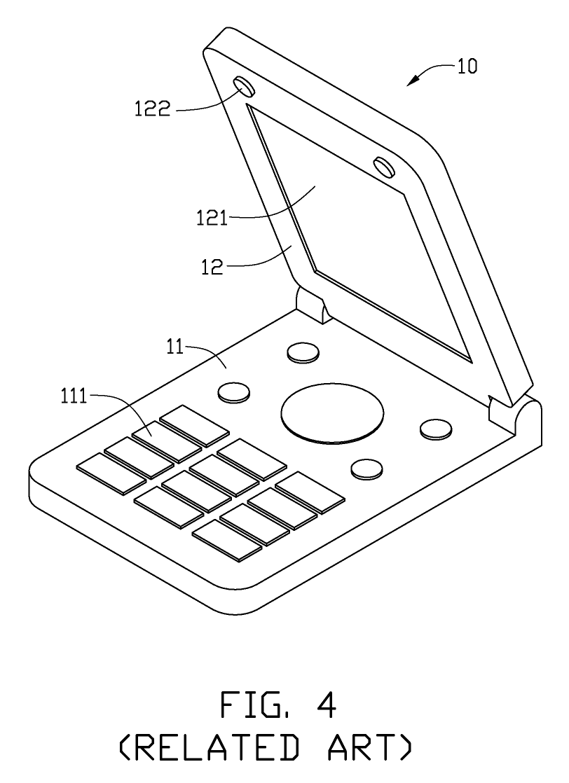

### DETAILED DESCRIPTION OF THE EMBODIMENTS

References will now be made to the drawings to describe the embodiments in detail.

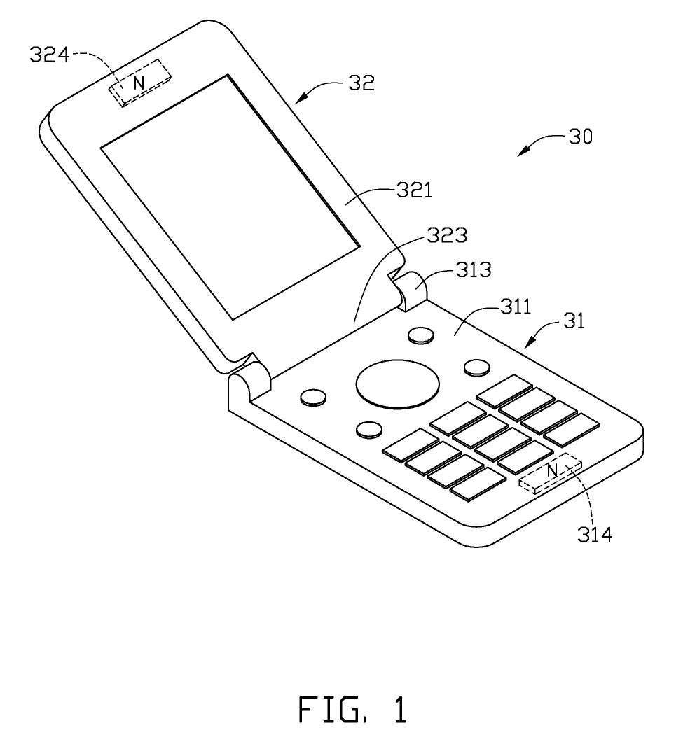

For the purpose of conveniently describing an exemplary folding-type electronic device, a mobile phone is described and illustrated. Referring to FIG. 1, a first embodiment of an electronic device 30 includes a main body 31, a cover 32, and a hinge (not shown) rotatably connecting the cover 32 to the main body 31. In the first embodiment, the electronic device 30 is a folding-type mobile phone.

The main body 31 may be substantially rectangular shaped. The main body 31 includes a first surface 311 facing the cover 32, when the cover 32 is rotated towards the main body 31. Two assembling portions 313 may be formed on a proximal end of the main body 31, and aligned in a straight line. A first magnet 314 is positioned in a distal end of the main body 31. The first magnet 314 is rectangular shaped. In the illustrated embodiment, an end of the first magnet 314 facing the cover 32 is a north polarity. It may be appreciated that the end of the first magnet 314 facing the cover 32 may be a south polarity.

The cover 32 may be substantially rectangular shaped. The cover 32 includes a second surface 321 facing the main body 31, when the cover 32 is rotated towards the main body 31. A connecting portion 323 may be formed on a distal end of the cover 32. A second magnet 324 is positioned in a proximal end of the cover 32. The second magnet 324 is rectangular shaped. In the illustrated embodiment, an end of the second magnet 324 facing the main body 31 is a north polarity. It may be appreciated that the end of the second magnet 324 facing the main body 31 may be the same polarity as the first magnet 314 facing the cover 32.

The hinge connects the connecting portion 323 of the cover 32 to the assembling portions 313 of the main body 31, so that the cover 32 is rotatably connected to the main body 31.

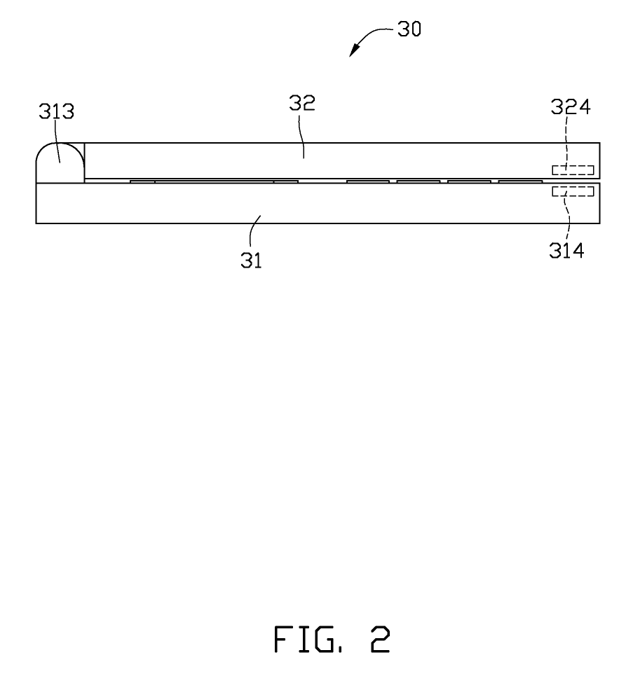

Referring to FIG. 2, when the cover 32 is rotated towards the main body 31, the first magnet 314 and the second magnet 324 are gradually brought close together. A repelling magnetic force is created between the first magnet 314 and second magnet 324 because the polarities of the first and second magnet 314, 324 are the same. The repelling magnetic force provides resistance to the cover 32 from rotating to the main body 31. The repelling magnetic force becomes stronger as the cover 32 is rotated closer to the main body 31 and the first and second magnets 314, 324 are brought closer together. When the cover 32 reaches a predetermined distance between the main body 31 and the cover 32, the magnetic force is equal to a net force of a weight of the cover 32 and a friction force of the hinge. At the predetermined distance, the cover 32 stops rotating relative to the main body 31.

Since a magnetism of the first magnet 314 or the second magnet 324 does not degenerate or weaken, even after a long service period, the magnetic force between the first magnet 314 and the second magnet 324 can continuously prevent the cover 12 striking against the main body 11 with an excessive force. Therefore, electronic components in the main body 31 or the cover 32 would be protected from damage due to the magnetic force between the first magnet 314 and the second magnet 324.

It should be pointed out that, the first magnet 314 and the second magnet 324 may be electromagnets. Thus, the magnetic force between the first magnet 314 and the second magnet 324 may be adjustable by changing an electric current in the first magnet 314 or the second magnet 324.

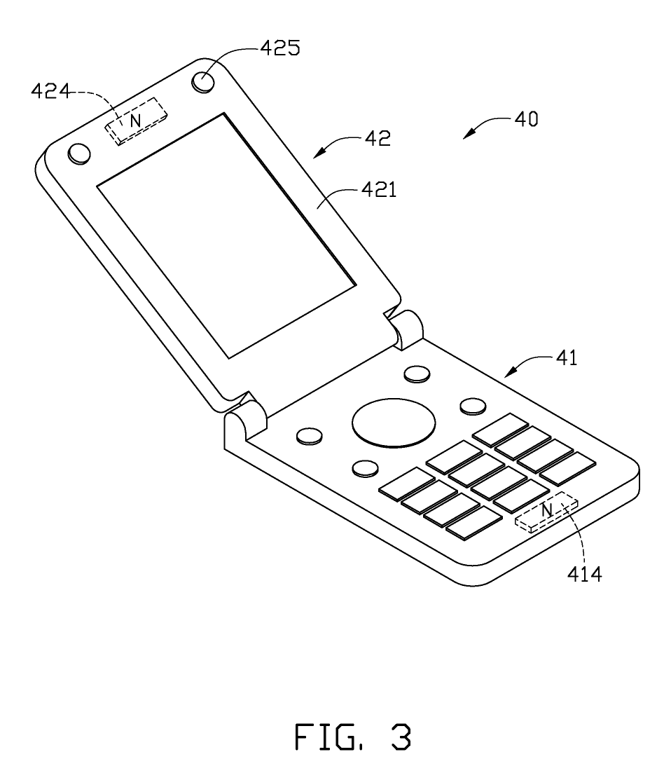

Referring to FIG. 3, a second embodiment of an electronic device 40 is similar to the first embodiment of the electronic device 30, except that at least one bumper 425 is formed on a second surface 421 of a cover 42. In the illustrated embodiment, two bumpers 425 are shown. The bumpers 425 may be made of a rubber. It may be appreciated that the bumpers 425 may be formed on a first surface (not labeled) of a main body 41.

When the cover 42 of the electronic device 40 is rotated to the main body 41, a repelling magnetic force is produced between a first magnet 414 positioned in the main body 41 and a second magnet 424 positioned in the cover 42. Thus, the bumpers 425 would touch the main body 41 gently, thereby reducing the wear and tear of the bumpers 425, and a service life of the bumpers 425 is prolonged.

It is believed that the present embodiments and their advantages will be understood from the foregoing description, and it will be apparent that various changes may be made thereto without departing from the spirit and scope of the or sacrificing all of its material advantages, the examples hereinbefore described merely being preferred or exemplary embodiments of the invention.

What is claimed is:

1. An electronic device, comprising:
a main body;
a cover rotatably connected to the main body;
a first magnet positioned in the main body; and
a second magnet positioned in the cover, wherein a polarity of the first magnet and a polarity of the second magnet are the same, such that a repelling magnetic force is produced when the cover is rotated towards the main body to prevent the cover from striking the main body.

2. The electronic device as claimed in claim 1, wherein an assembling portion is formed on an end of the main body; a connecting portion is formed on an end of the main body; the connecting portion is rotatably connected to the assembling portion.

3. The electronic device as claimed in claim 2, wherein the first magnet is positioned in an end of the main body away from the assembling portion; the second magnet is positioned in an end of the cover away from the connecting portion.

4. The electronic device as claimed in claim 1, wherein at least one bumper is formed on the cover at the end adjacent to the second magnet.

5. The electronic device as claimed in claim 4, wherein the at least one bumper comprises two bumpers formed on the cover on opposite sides of the second magnet.

6. The electronic device as claimed in claim 5, wherein the bumpers are made of rubber.

7. The electronic device as claimed in claim 1, wherein at least one bumper is formed on the main body at the end adjacent to the first magnet.

8. The electronic device as claimed in claim 7, wherein the at least one bumper comprises two bumpers formed on the main body on opposite sides of the first magnet.

9. The electronic device as claimed in claim 8, wherein the bumpers are made of rubber.

10. The electronic device as claimed in claim 1, wherein at least one of the first magnet and the second magnet is an electromagnet.

11. The electronic device as claimed in claim 10, wherein the electromagnet is adjustable by changing an electric current therein.

12. The electronic device as claimed in claim 1, wherein the first magnet is rectangular shaped.

13. The electronic device as claimed in claim 12, wherein the second magnet is rectangular shaped.

14. The electronic device as claimed in claim 1, wherein the electronic device is a mobile phone.
